(19) United States
(12) Patent Application Publication
(10) Pub. No.: US 2026/0138542 A1
(43) Pub. Date: May 21, 2026

(54) TABLE ARRANGEMENT FOR VEHICLE

(71) Applicant: BOS Automotive Products, Inc., Rochester Hills, MI (US)

(72) Inventors: Mickey Alan HANNAN, Shelby Township, MI (US); Satya Akhil Reddy BACHUGUDAM, Rochester Hills, MI (US)

(21) Appl. No.: 19/395,441

(22) Filed: Nov. 20, 2025

Related U.S. Application Data
(60) Provisional application No. 63/723,331, filed on Nov. 21, 2024.

(51) Int. Cl. B60R 13/01

(52) U.S. Cl. CPC B60R 13/013; B60R 2013/016; B60R 2013/018

(57) ABSTRACT

A table arrangement for a vehicle including a housing having a bottom wall with an upwardly facing surface defining a support surface for storing or transporting items in a cargo space of the vehicle, a storage space disposed below the bottom wall and a table assembly. The table assembly includes a table with a generally planar upper surface and a conveying arrangement at least partially disposed in the storage space and operatively connected to the table. The conveying arrangement conveys the table between a storage position and at least one use position. The table in the storage position is disposed adjacent the bottom wall and in substantially flush relation therewith, such that the table defines part of the support surface in the closed position, and the table in the at least one use position is spaced upwardly from the bottom wall for convenient access by the user.

### CROSS-REFERENCE TO RELATED APPLICATION

This claims priority from U.S. Provisional Application Serial No. 63/723 331, filed on Nov. 21, 2024, the disclosure of which is incorporated by reference in its entirety.

### TECHNICAL FIELD

This relates to a table arrangement for use in a cargo space of a vehicle.

### BACKGROUND AND SUMMARY

Storage and functional space within a motor vehicle is a valuable resource, and maximizing the use of such space is highly desirable in all types of vehicles, including trucks, passenger cars, sport utility vehicles (SUVs), cross-over vehicles (CUVs) and electric vehicles (EVs). Such vehicles are used for both work and recreational purposes, and having a readily usable support or work surface is both convenient and sometimes necessary depending on the planned activity of the vehicle occupant(s). For example, it may be desirable to have a table available for an outdoor activity, such as a music or sporting event or a picnic, to display or store items, or to provide a dining surface. Another convenient use for a table is to serve as a work bench for supporting/organizing tools needed for a particular job. A conventional, stand-alone table may be stored in a vehicle for these uses. However, such tables typically occupy a large amount of space in the vehicle and can shift unexpectedly as a result of movement of the vehicle, which could cause harm to the vehicle occupants and/or damage the vehicle.

In order to improve on conventional table arrangements, one aspect of the invention provides a table arrangement incorporated into a vehicle cargo space and forming part of the load floor thereof, which vehicle may be any of the types discussed above. The table arrangement includes a table assembly with a tabletop or platform. The table assembly is normally positioned in a storage or closed position in which the tabletop is oriented substantially horizontally and functions as, or as part of, the cargo floor of the vehicle cargo space. When use of the table arrangement is desired in order to support or store items or for use as a worksurface or eating surface, the table assembly is movable from the storage/closed position into one or more use positions. One of such use positions includes having the tabletop elevated from the storage/closed position for convenient access by the user. An additional use position includes having the tabletop extended horizontally outwardly from the cargo area so as to be spaced from the edge portion thereof, which also provides convenient user access and helps to prevent bumping of the user's legs into the edge during use of the table arrangement.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the object being described and of designated parts thereof. Additionally, the terms “frontwardly” and “rearwardly” will be in reference to the front-to-back direction of a motor vehicle. Said terminology will include the words specifically mentioned, derivatives thereof, and words of similar import.

### BRIEF DESCRIPTION OF THE DRAWINGS

FIG. 1 is a perspective view of the table arrangement incorporated into a cargo space of a motor vehicle, with the table assembly of the table arrangement in the closed/storage position;

FIG. 2 is a perspective view of the table arrangement, with the table assembly of the table arrangement in the closed/storage position;

FIG. 3 is an exploded view of the table arrangement;

FIG. 4 is a top view of the housing shell of the table arrangement;

FIG. 5 is an enlarged and fragmentary cross-sectional view of the housing shell of the table arrangement, as seen substantially along line 5-5 of FIG. 4;

FIG. 6 is an enlarged and fragmentary cross-sectional view of the housing shell of the table arrangement, as seen substantially along line 6-6 of FIG. 4;

FIG. 7 is a front perspective view of the front panel of the housing shell of the table arrangement;

FIG. 8 is a top view of the table assembly of the table arrangement;

FIG. 9 is a perspective view of the table assembly of the table arrangement;

FIG. 10 is an enlarged bottom perspective view of the table assembly of the table arrangement;

FIG. 11 is an enlarged exploded view of the link arm assembly of the table arrangement;

FIG. 12 is a side view of the front link arm of the link arm assembly;

FIG. 13 is a perspective view of the front link arm in a reversed orientation from that shown in FIG. 12;

FIG. 14 is a side view of the rear link arm of the link arm assembly;

FIG. 15 is a rear perspective view of the front link arm;

FIG. 16 is an additional rear perspective view of the front link arm;

FIG. 17 is a front perspective view of the front link arm;

FIG. 18 is a perspective view of the outer side of one L-shaped bracket of the link arm mounting arrangement;

FIG. 19 is a perspective view of the inner side of the L-shaped bracket shown in FIG. 18;

FIG. 20 is a bottom perspective view of the L-shaped bracket shown in FIG. 18;

FIG. 21 is a top view of the L-shaped bracket shown in FIG. 18;

FIG. 22 is a front view of the table arrangement, with the table assembly in the closed position;

FIG. 23 is an enlarged fragmentary cross-sectional view of the table arrangement, as seen substantially along line 23-23 in FIG. 22;

FIG. 24 is an enlarged fragmentary cross-sectional view of the table arrangement, as seen substantially along line 24-24 in FIG. 22;

FIG. 25 is side view of the table arrangement with the table assembly in the closed position;

FIG. 26 is a top view of the table arrangement with the table assembly in the closed position;

FIG. 27 is a bottom perspective view of the table arrangement with the table assembly in the closed position;

FIG. 28 is a perspective view of the table arrangement with the table assembly in the first upper use position;

FIG. 29 is a front view of the table arrangement with the table assembly in the first upper use position;

FIG. 30 is an enlarged fragmentary cross-sectional view of the table arrangement, as seen substantially along line 30-30 of FIG. 29;

FIG. 31 is a top view of the table arrangement with the table assembly in the first upper use position;

FIG. 32 is a perspective view of the table arrangement with the table assembly in the second extended use position;

FIG. 33 is a top view of the table arrangement with the table assembly in the second extended use position;

FIG. 34 is an enlarged fragmentary cross-sectional view of the table arrangement with the table assembly in the second extended use position, as seen substantially along line 34-34 of FIG. 33;

FIG. 35 is an enlarged side view of an alternative embodiment of the table assembly;

FIG. 36 is an enlarged side view of the table assembly of FIG. 35 in the extended use configuration;

FIG. 37 is a perspective view of a further embodiment of the table arrangement, with the table assembly of the table arrangement in the closed/storage position;

FIG. 38 is a perspective view of the table arrangement of FIG. 37, with the table assembly in the use position;

FIG. 39 is top view of the table arrangement of FIG. 37, with the table assembly in the use position;

FIG. 40 is an enlarged bottom perspective view of the table assembly of the table arrangement of FIG. 37;

FIG. 41 is a front perspective view of the front panel of the housing shell of the table arrangement of FIG. 37;

FIG. 42 is an enlarged cross-sectional view of the table arrangement of FIG. 37, as seen substantially along line 42-42 in FIG. 37;

FIG. 43 is a fragmentary cross-sectional view of the table arrangement of FIG. 37, as seen substantially along line 43-43 in FIG. 39;

FIG. 44 is an enlarged detail view from FIG. 43 of the locking arrangement of the table assembly of the table arrangement of FIG. 37;

FIG. 45 is an enlarged cross sectional view of the locking arrangement of the table assembly of the table arrangement of FIG. 37, as seen substantially along line 45-45 of FIG. 39;

FIG. 46 is side view of the release cam of the locking arrangement of the table assembly of the table arrangement of FIG. 37;

FIG. 47 is a side view of the striker cam of the locking arrangement of the table assembly of the table arrangement of FIG. 37;

FIG. 48 is a side view of the release and striker cams of the locking arrangement in the unlocked position when the table assembly is in the closed/storage position; and

FIG. 49 is a front perspective view of the table arrangement of FIG. 37, with the table assembly in the use position.

### DETAILED DESCRIPTION

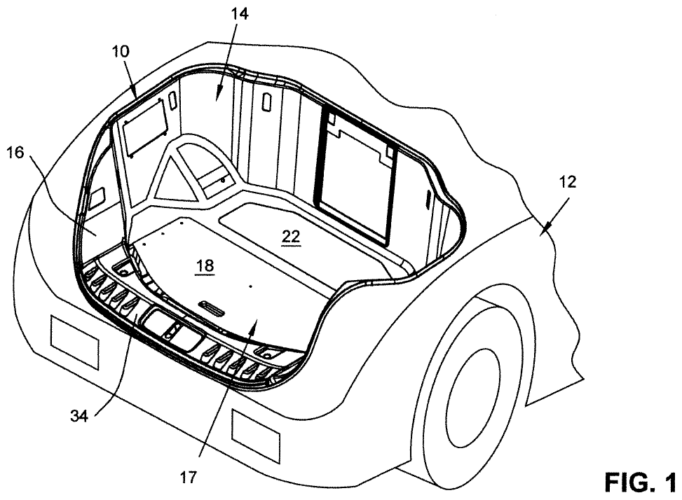

FIG. 1 illustrates a table arrangement 10 according to the invention incorporated into a motor vehicle 12. The motor vehicle 12 may be any type of vehicle, for example a passenger car, a sport utility vehicle (SUV), a cross-over vehicle (CUV) an electric vehicle (EV) or a pickup truck. The vehicle 12 includes a cargo space 14, which is typically used for storing and/or transporting items. The cargo space 14 may be located in the rear or front of the vehicle 12. In the illustrated embodiment, the table arrangement 10 is incorporated into and forms a front cargo space 14 of the type typically found in an electric vehicle, sometimes referred to as a “frunk”. It will be appreciated that the table arrangement 10 as disclosed herein may alternatively be incorporated into the floor of a bed of a pickup truck, for example adjacent the tail gate at the rear of the truck bed. The cargo space 14 as illustrated in FIG. 1 is normally covered by a closure or hood (not shown), which closure or hood is pivotable between open and closed positions about a generally horizontally oriented axis located adjacent a rear of the closure or hood.

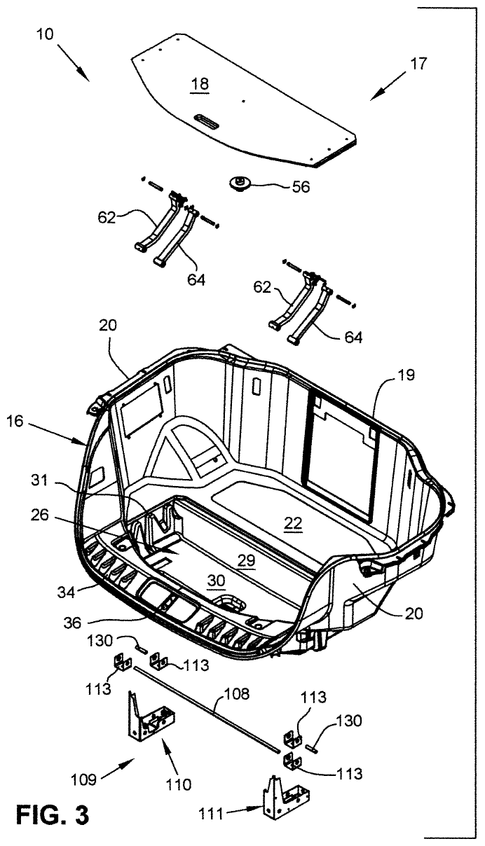

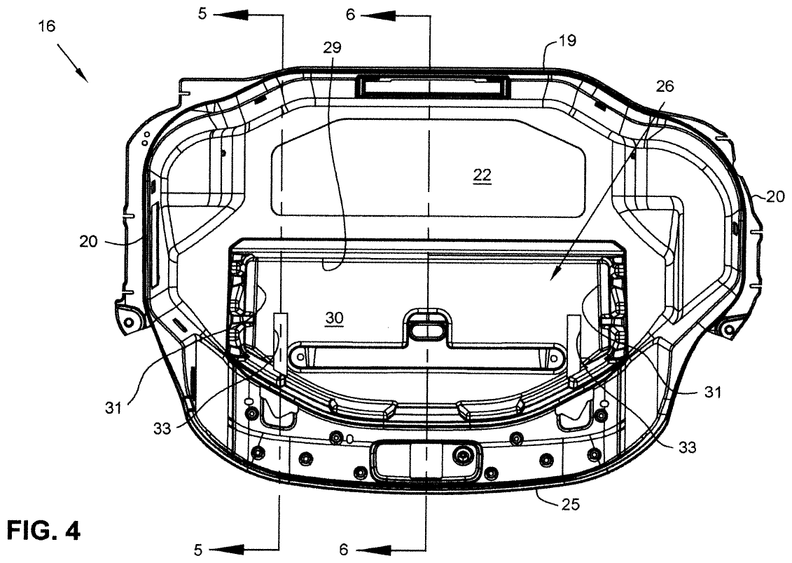

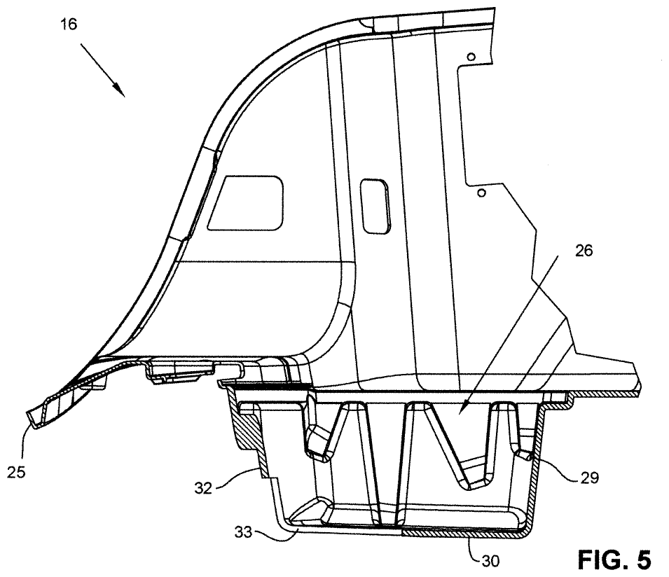

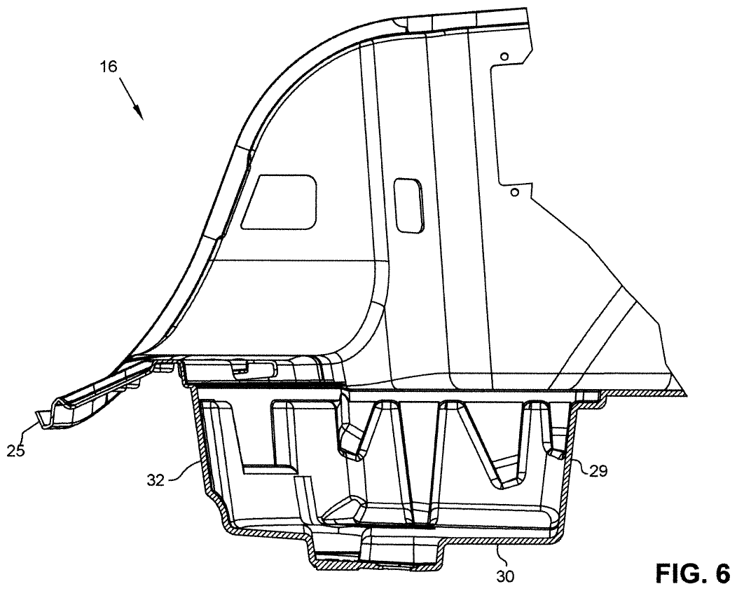

With reference to FIGS. 1-4, the table arrangement 10 generally includes a housing shell 16 and a table assembly 17 incorporated into a lower portion of the housing shell 16. The table assembly 17 includes a tabletop 18. The housing shell 16 includes a generally upright rear wall 19, a pair of laterally spaced and generally upright side walls 20 adjoined to respective opposite sides of the rear wall 19 and a bottom wall 22 extending between and interconnecting the rear wall 19 and the side walls 20. The tabletop 18 is positioned forwardly of the bottom wall 22 within the housing shell 16, so that the tabletop 18 and the bottom wall 22 are generally flush with one another and together define a generally horizontal cargo support surface within the cargo space 14 on which items can be stored and transported when the table assembly 17 is not in use. The housing shell 16 opens frontwardly through a front edge portion 25 if the table arrangement 10 is incorporated into a front cargo space 14, or rearwardly through a rear edge portion if the table arrangement 10 is incorporated in a rear cargo space 14. As best shown in FIGS. 3 and 4, the housing shell 16 defines a lower storage compartment 26 located beneath the tabletop 18. More specifically, the housing shell 16 includes an intermediate generally upright wall 29 adjoined to a front edge portion of the bottom wall 22, a generally horizontal bottom wall 30 adjoined to a lower edge of the intermediate wall 29, a pair of laterally spaced and generally upright intermediate side walls 31 adjoined to respective opposite sides of the intermediate wall 29 and the bottom wall 30, which intermediate side walls 31 are joined to the respective side walls 20, and a generally upright front wall 32 (see FIG. 5) which at its upper edge adjoins the front edge portion 25 of the housing shell 16. The housing shell 16 defines therein a pair of laterally spaced openings 33 which extend through both the bottom wall 30 and the front wall 32. The lower storage compartment 26 is generally rectangular in shape and opens upwardly, and is closed by the tabletop 18 when the table assembly 17 is not in use. The storage compartment 26 is used to store components of the table assembly 17 when in the lowered closed position, as discussed further below.

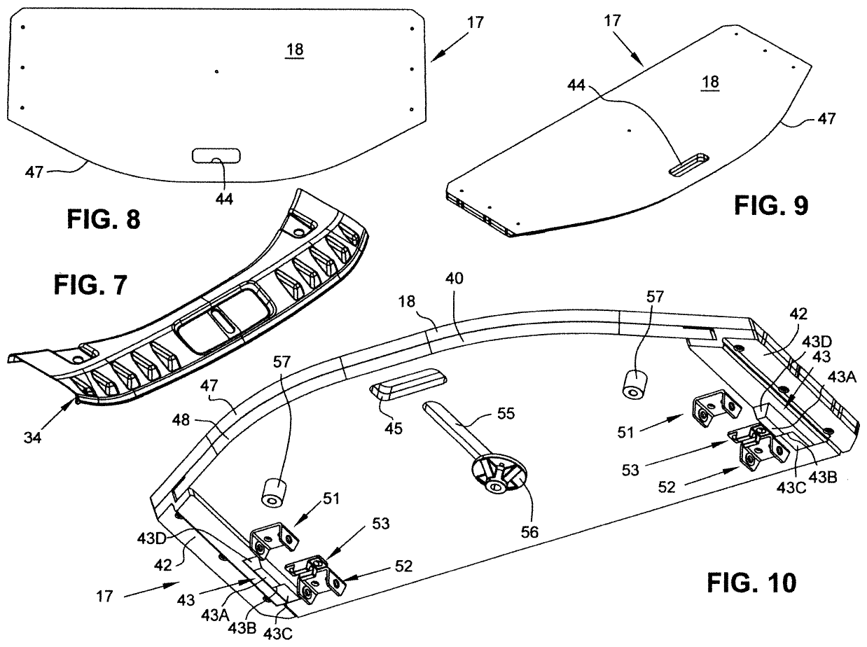

As shown in FIGS. 3 and 7, the front edge portion 25 of the housing shell 16 fixedly mounts thereon a front panel 34, which front panel 34 forms the terminal frontmost part of the table arrangement 10. Each of the front edge portion 25 and the front panel 34 define respective centrally located openings therein, which openings are vertically aligned with one another when the front panel 34 is installed on the front edge portion 25 of the housing shell 16. The aligned openings together define an opening 36 for receiving a conventional lower closure element (not shown) for securing the vehicle hood in a closed position.

Turning now to the table assembly 17 and with reference to FIGS. 3 and 8-10, the table assembly 17 includes the tabletop 18 which forms a movable upper table member of the table assembly 17, and a lower stationary table member 40. The upper table member or tabletop 18 and the lower table member 40 are rigid planar components, with the tabletop 18 being positioned atop the lower table member 40. In this regard and in the illustrated embodiment, the tabletop 18 has fixed thereon a pair of elongate channel members 42. The channel members 42 are fixed to a lower surface of the tabletop 18 and extend in a front to rear direction along respective opposite lateral edges thereof, with the channels of the channel members 42 opening inwardly and towards one another. Each of the channel members 42 includes a cam member 43 fixed to a lower surface thereof, which cam member 43 includes a lower planar cam surface 43A, an upper planar cam surface 43C and an intermediate and angled cam surface 43B extending between the lower and upper cam surfaces 43A and 43C. The lower cam surface 43A has a greater vertical dimension than the upper cam surface 43C, and is adjoined to a further angled cam surface 43D. Opposite lateral edges of the lower table member 40 are disposed within the respective channels of the channel members 42 to permit horizontal sliding movement of the tabletop 18 relative to and along the lower table member 40. The configuration of the channel members 42 allows for frictional engagement between the tabletop 18 and the lower table member 40 so that the tabletop 18 is not loosely attached to the lower table member 40, but instead so that a sufficient force is required to shift the tabletop 18 relative to the lower table member 40. In this regard, the table assembly 17 may include a wave spring or other frictional element within each of the respective channel members 42 so as to provide the proper friction between the tabletop 18 and the lower table member 40.

The tabletop 18 and the lower table member 40 each define therein respective identical elongated openings 44 and 45 located centrally between lateral edges thereof and at a small distance rearwardly from their respective frontmost edges 47 and 48, which openings 44 and 45 serve as a handle for manipulating the table assembly 17 as discussed further below. In the illustrated embodiment, the frontmost edges 47 and 48 are arcuate and has a similar curvature. It will be appreciated that other edge configurations are within the scope of the invention.

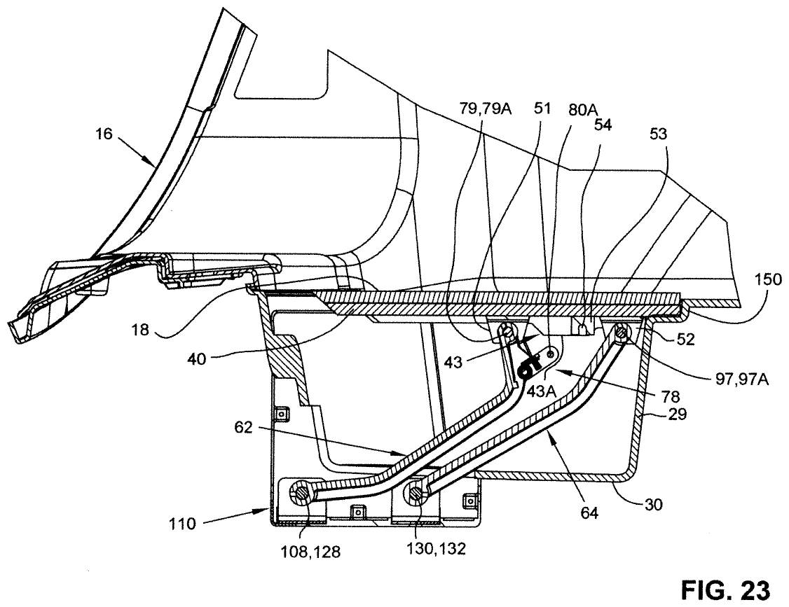

With reference to FIG. 10, the table assembly 17 additionally includes two pairs of bracket assemblies fixed to a lower side of the lower table member 40 adjacent the opposite lateral edges thereof and inwardly of the respective cam members 43. Each pair of bracket assemblies includes identical front and rear bracket members 51 and 52 and a stop bracket 53 disposed between the front and rear bracket members 51 and 52. Each bracket member 51 and 52 is generally U-shaped and includes a base portion and two side flanges projecting downwardly from respective opposite edges of the base portion. The side flanges of each bracket member 51 and 52 define respective aligned openings therein. The front and rear bracket members 51 and 52 of each bracket pair are fixed to the lower side of the lower table member 40 adjacent, but spaced inwardly from, the respective channel members 42 of the tabletop 18, with the front bracket 51 of each pair being disposed closer to the frontmost edge 48 of the lower table member 40 than the corresponding rear bracket member 52 and so that the base portions of the bracket members are disposed immediately adjacent the lower side of the lower table member 40 with the side flanges projecting downwardly so that the U-shape opens downwardly and away from the tabletop 18. Each of the stop brackets 53 of each bracket assembly defines therein a channel 54 which is generally semi-circular in cross-section (see also FIG. 23), is oriented so as to open downwardly and extends in a lateral direction of the lower table member 40.

In this embodiment, the lower table member 40 defines therein a slot 55 which is elongated in a front-to-rear direction of the table assembly 17 and is located centrally between the lateral edges thereof. A stop or travel limiter 56 is fixed to the lower side of the tabletop 18 and is located in, and slidable relative to, the slot 55 of the lower table member 40. The table assembly 17 further includes a pair of laterally spaced supports 57 fixed to the lower surface of the lower table member 40 and projecting downwardly therefrom on opposite sides of the slot 55.

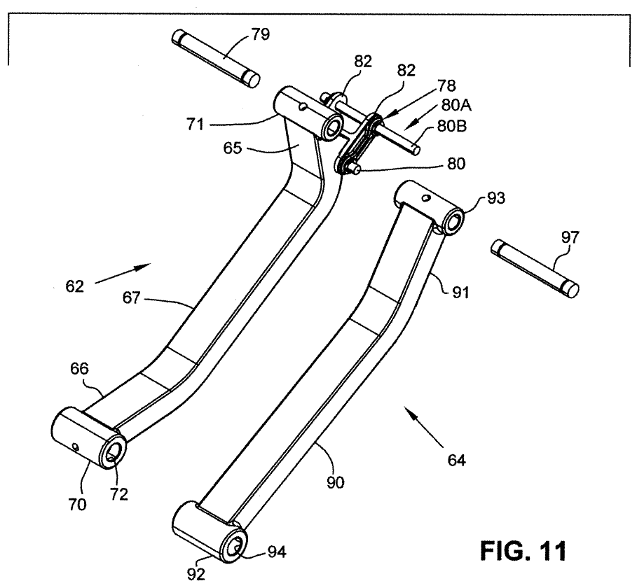

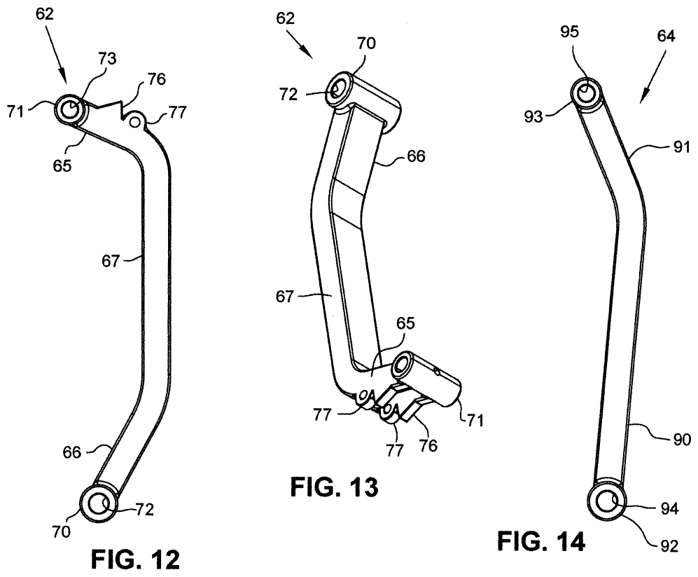

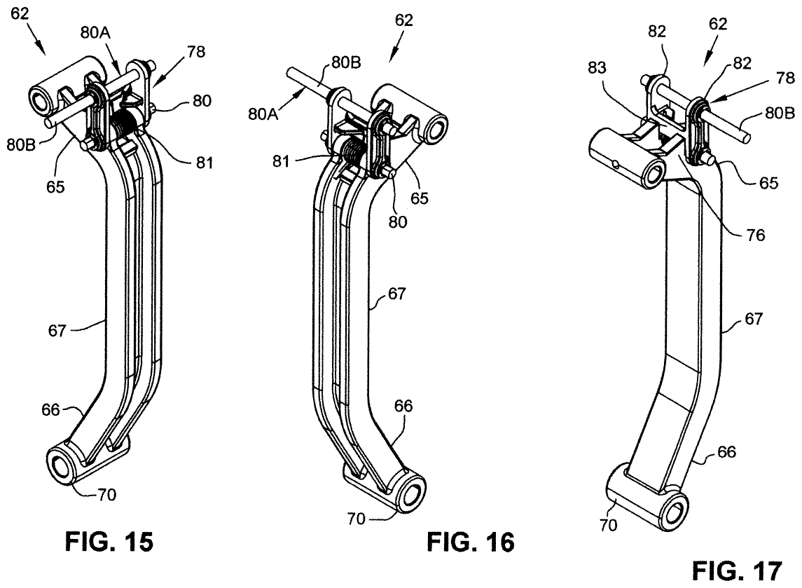

The table assembly 17 additionally includes, as shown in FIGS. 3 and 11-17, a mechanism or arrangement for conveying the table assembly 17 between various use positions. More specifically, the conveying mechanism or arrangement in the illustrated embodiment includes a link arm assembly including two identical pairs of rigid front and rear link arms. Each pair of link arms includes a front link arm 62 and a rear link arm 64. Each of the front link arms 62 includes an upper arm segment 65, a lower arm segment 66 and an intermediate arm segment 67 disposed between and interconnecting the upper and lower arm segments 65 and 66. Further, each front link arm 62 includes a generally cylindrical lower mounting member 70 fixed to a terminal end of the lower arm segment 66 and a generally cylindrical upper mounting member 71 fixed to a terminal end of the upper arm segment 65. The lower and upper mounting members 70 and 71 include respective holes 72 and 73 which extend completely therethrough so as to open outwardly through opposite ends of the respective mounting member for receiving respective pins, with only the upper pin 79 being shown in FIG. 11. The upper arm segment 65, the intermediate arm segment 67 and the upper arm segment 66 of each front link arm 62 are substantially straight components and the upper and lower arm segments are each oriented at an angle relative to the intermediate arm segment 67, as best shown in FIG. 12. Adjacent the mounting member 71 of the upper arm segment 65, each front link arm 62 includes a pair of laterally spaced and identical stops 76 and a pair of laterally spaced and identical mounting elements 77 disposed immediately adjacent the respective stops 76, with the stops 76 being disposed on the upper arm segment 65 between the mounting member 70 and the mounting elements 77.

With reference to FIGS. 11 and 15-17, the table assembly 17 incorporates a locking mechanism on the upper arm segment 65 of each of the front link arms 62. The locking mechanism includes a latch 78 which is generally H-shaped, pins 80A and 80 and a spring 81. The latch 78 includes a pair of arms 82 which are generally parallel to one another and spaced laterally from one another by a central support 83 which extends between and interconnects the arms 82. The arms 82 on upper ends thereof define openings which are aligned with one another and receive the pin 80A. The pins 80A are longer than the pins 80 and have respective cam-engaging outer free ends 80B. Lower ends of the arms 82 also define openings which are aligned with one another. The latch 78 is mounted on the upper arm segment 65 so that the central support 83 is normally biased against the stops 76 of the upper arm segment 65 by the spring 81, and the pin 80 extends through through-openings in the mounting elements 77 of the upper arm segment 65 and through the openings on the lower ends of the arms 82 to pivotably attach the latch 78 to the front link arm 62. When moving the table assembly 17 into its various use positions as discussed further below, the latch 78 is pivotable about a pivot axis defined by the pin 80 against the biasing force of the spring 81. The pins 80A of the respective latches 78 of the front link arms 62 cooperate with the respective stop brackets 53 provided on the lower table member 40 and with the respective cam members 43 provided on the tabletop 18, as discussed further below.

Turning now to the rear link arms 64 of the table assembly 17, each rear link arm 64 includes a lower arm segment 90 and an upper arm segment 91, which segments are adjoined to one another at an angle as shown in FIGS. 11 and 14. Further, each rear link arm 64 includes a generally cylindrical lower mounting member 92 fixed to a terminal end of the lower arm segment 90 and a generally cylindrical upper mounting member 93 fixed to a terminal end of the upper arm segment 91. The mounting members 92 and 93 include respective holes 94 and 95 which extend completely through the respective mounting member so as to open outwardly through opposite ends thereof for receiving respective pins, with only the upper pin 97 being shown in FIG. 11.

The two pairs of front and rear link arms 62 and 64 are mounted to the lower side of the lower table member 40. The upper mounting member 71 of each front link arm 62 is inserted into the front bracket 51 of one of the pairs of brackets, so that the opening 73 is aligned with the holes in the flanges of the front bracket 51, and the pin 79 is inserted through the aligned openings. Clips or clamps (not shown) are assembled onto the terminal exposed ends of the pin 79 to prevent dislodgement thereof from the upper mounting member 71. The upper mounting member 93 of each rear link arm 64 is inserted into the rear bracket 52 so that the opening 95 is aligned with the holes in the flanges of the rear bracket 52, and the pin 97 is inserted through the aligned openings. Clips or clamps (not shown) are assembled onto the terminal exposed ends of the pin 97 to prevent dislodgement thereof. The pins 79 and 97 respectively define pivot axes 79A and 97A about which the front and rear link arms 62 and 64 pivot relative to the tabletop 18 and lower table member 40 (see FIG. 23).

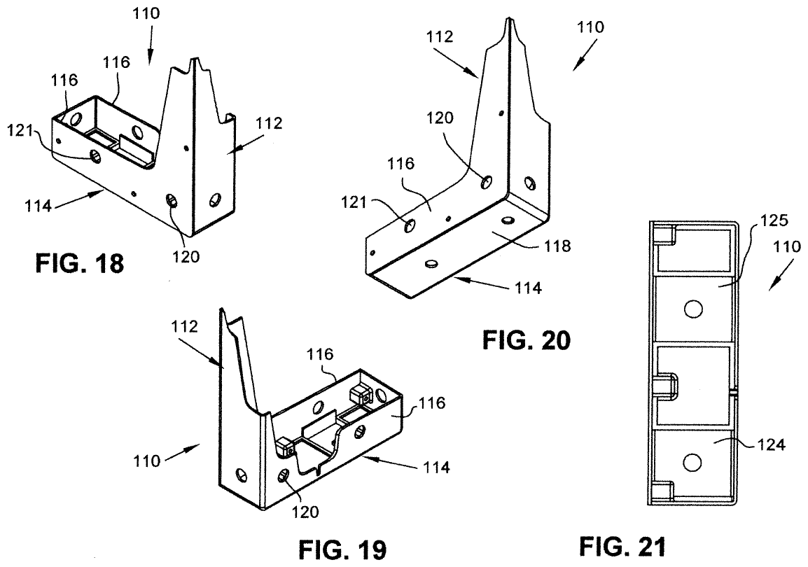

The conveying mechanism of the table arrangement 10 further includes a lower link arm mounting arrangement 109 having a pair of L-shaped brackets 110 and 111, each mounting therein two substantially identical reinforcing bracket inserts 113, and a rigid pivot rod 108, as best shown in FIGS. 3 and 18-21. The brackets 110 and 111 are mirror images of one another and only the leftmost bracket 110 in FIG. 3 is accordingly described herein. The bracket 110 includes an upright leg 112 joined at its lower end to a generally horizontal lower leg 114. The lower leg 114 is generally in the form of an upwardly opening channel formed by two substantially upright side walls 116 and a bottom wall 118 extending between and interconnecting lower ends of the side walls 116. Each of the side walls 116 of the bracket 110 defines a plurality of mounting holes therein. More specifically, each side wall 116 defines therein a front mounting opening or through-hole 120 and a rear mounting opening or through-hole 121. The front openings 120 of the side walls 116 of the bracket 110 are aligned with one another and the rear openings 121 are aligned with one another. The lower leg 114 in the illustrated embodiment defines two upwardly opening front and rear compartments 124 and 125 therein in which the respective bracket inserts 113 are disposed. The bracket inserts 113 each include a bottom wall and a pair of substantially parallel upright flanges, and the flanges of each bracket insert 113 have openings formed therein which are aligned with one another. The bracket inserts 113 are fixedly mounted within the respective compartments 124 and 125 of the lower leg 114 so that the bottom bracket wall of each bracket insert 113 is positioned atop the inner surface of the bottom wall 118 of the bracket 110. When the bracket inserts 113 are installed within the respective compartments 124 and 125 of the lower leg 114 of the bracket 110, the openings in the flanges of the frontmost bracket 113 (located in the front compartment 124) align with the front openings 120 of the bracket 110 and the openings in the flanges of the rearmost bracket 113 (located in the rear compartment 125) align with the rear openings 121 of the bracket 110.

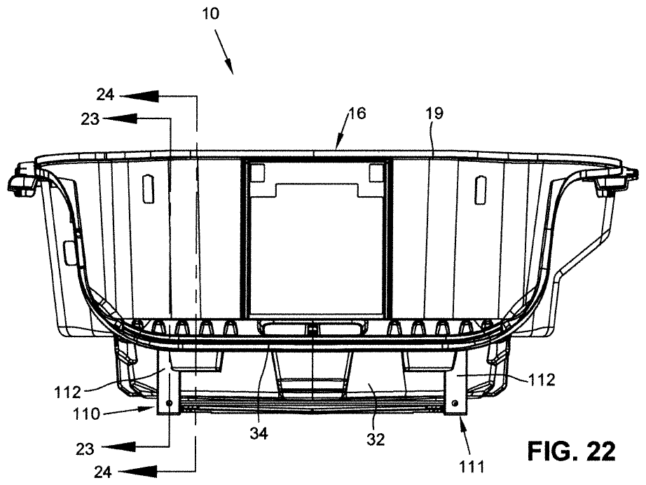

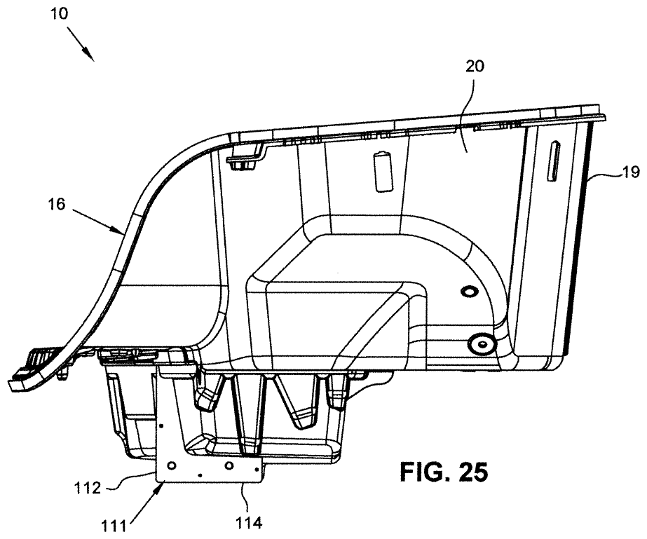

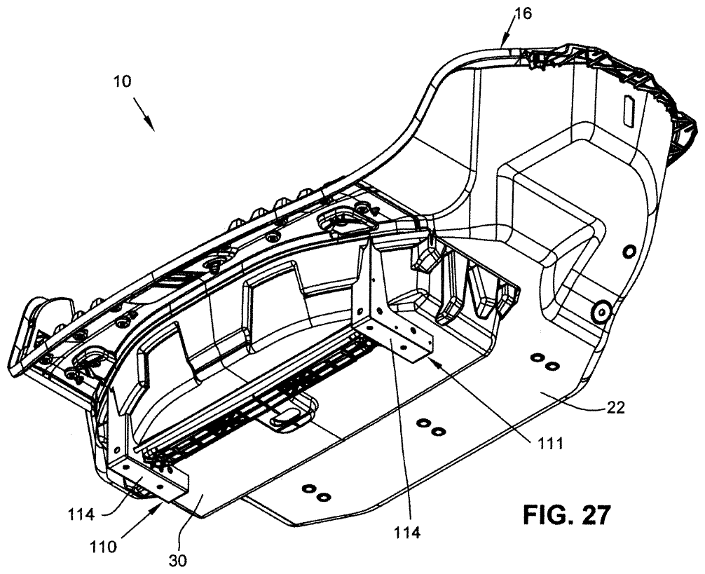

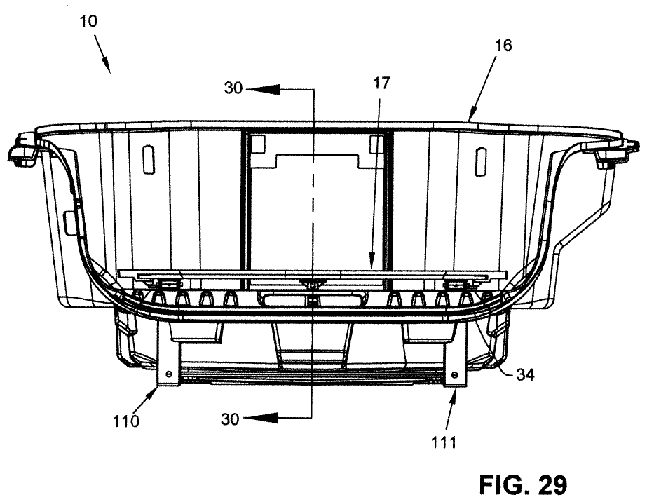

The front link arms 62 are assembled to the L-shaped brackets 110 and 111 of the link arm mounting arrangement 109 by inserting the lower mounting members 70 of the front link arms 62 into the respective front compartments 124 of the L-shaped brackets 110 and 111 and extending opposite ends of the pivot rod 108 through the front mounting openings 120 of each of the brackets 110 and 111 and through the openings 72 of the lower mounting members 70 of the front link arms 62 positioned within the respective brackets 110 and 111. The outer ends of the pivot rod 108 located on outer ones of the side walls 116 of the L-shaped brackets 110 and 111 may be provided with clips or clamps (not shown) to prevent lateral shifting of the pivot rod 108 once assembled to the front link arms 62 and brackets 110 and 111. The pivot rod 108 thus defines a generally horizontal pivot axis 128 (see FIG. 23) about which the front link arms 62 pivot during use of the table arrangement 10. The rear link arms 64 are assembled to the L-shaped brackets 110 and 111 by inserting the mounting members 92 of the rear link arms 64 into the respective rear compartments 125 of the L-shaped brackets 110 and 111, and a pin 130 (see FIG. 3) is used to secure each of the rear link arms 64 to the L-shaped brackets 110 and 111. Specifically, each pin 130 extends through the rear openings 121 of the lower leg 114 and through the opening 94 of the respective rear link arm 64, which rear link arm 64 is positioned between the rear openings 121 of the lower leg 114 inside the rear compartment 125. The pins 130 may be secured at opposite ends thereof to prevent dislodgement of the pins 130 once assembled to the brackets 110 and 111 and the rear link arms 64. The pins 130 are axially aligned with one another and together define a generally horizontal pivot axis 132 about which the rear link arms 64 pivot during use of the table arrangement 10. As best shown in FIGS. 22, 24, 25, 27 and 29, the L-shaped brackets 110 and 111 are mounted to the housing shell 16 on opposite sides thereof, so that their upright legs 112 are positioned against the front wall 32 of the lower storage compartment 26 and so that their lower legs 114 are positioned against the bottom wall 30 of the lower storage compartment 26. When the table arrangement 10 is assembled, the front and rear link arms 62 and 64 extend upwardly from the respective L-shaped brackets 110 and 111 and through the respective slots 33 formed in the housing shell 16.

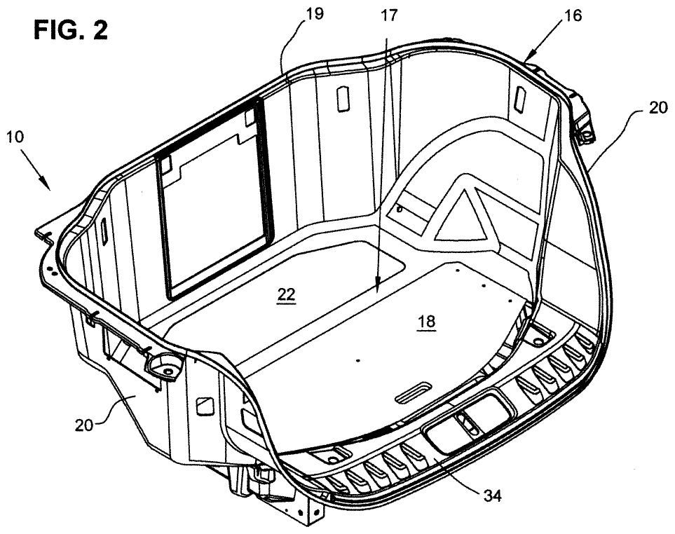

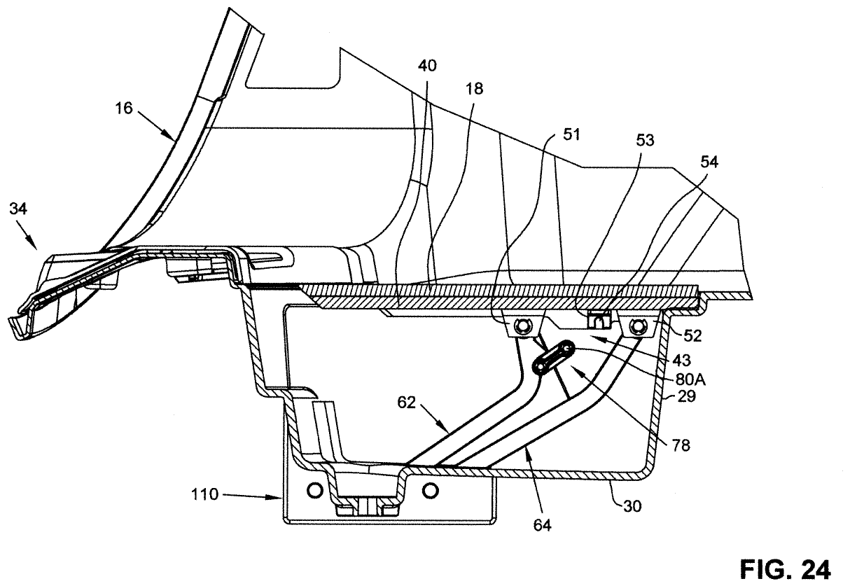

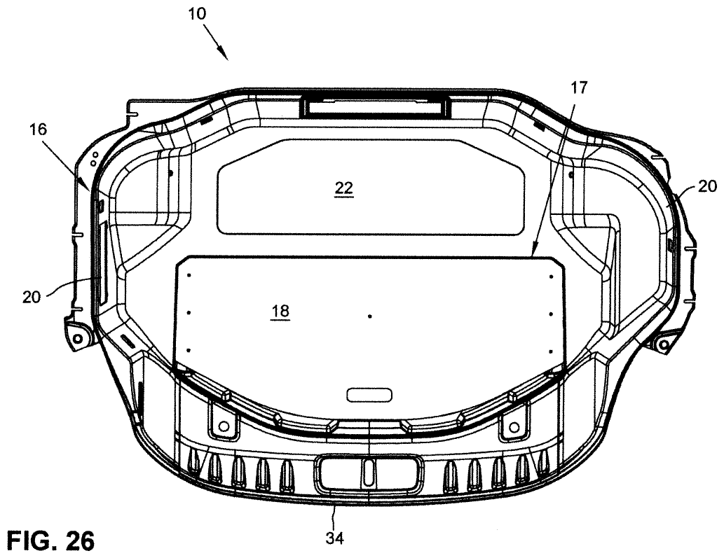

When the table assembly 17 is not in use, the link arm assembly, including the pairs of front and rear link arms 62 and 64, is stored in the lower storage compartment 26 and the tabletop 18 is generally flush with the bottom wall 22 of the housing shell 16 as shown in FIGS. 23 and 24. This closed position of the table assembly 17 is also illustrated in FIGS. 2 and 26. The cargo space 14 in this position of the table assembly 17 can be used for storage. In the closed or storage position, and with continued reference to FIGS. 23 and 24, the front and rear link arms 62 and 64 are positioned so as to extend generally rearwardly and upwardly, and the tabletop 18 and the lower table member 40 are stacked vertically with their rear longitudinal edges positioned in a corner-shaped portion 150 of the upright wall 29 of the housing shell 16 at a rear of the storage compartment 26. The weight of the table assembly 17 and friction between same and the housing shell 16 maintain the table assembly 17 in the closed position. However, it will be appreciated that a locking mechanism can be provided to positively lock the table assembly 17 to the housing shell 16. In the closed position, the pins 80A of the latches 78 on the front link arms 62 are spaced downwardly from the respective cam members 43 and from the respective stop brackets 53 on the lower surface of the lower table member 40.

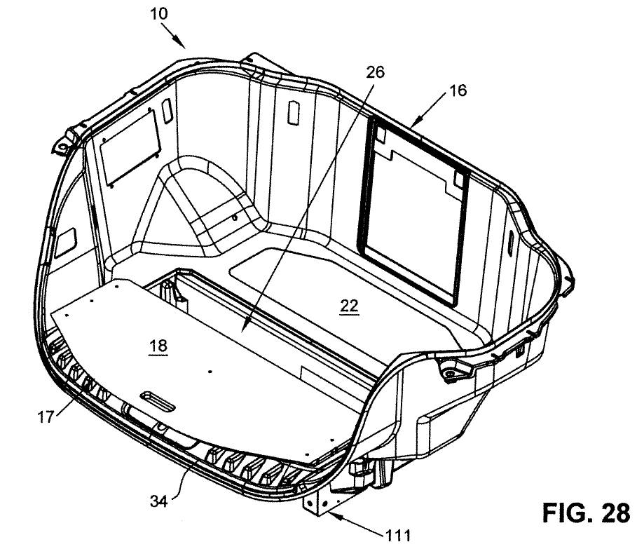

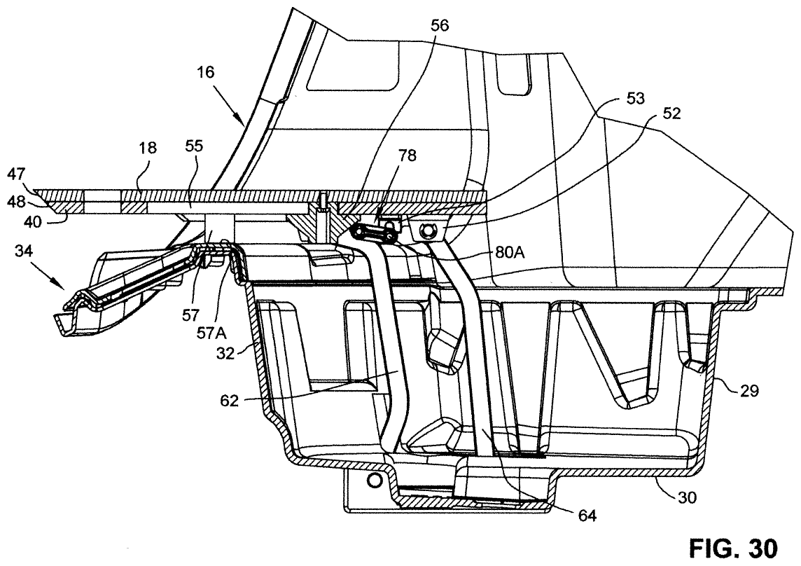

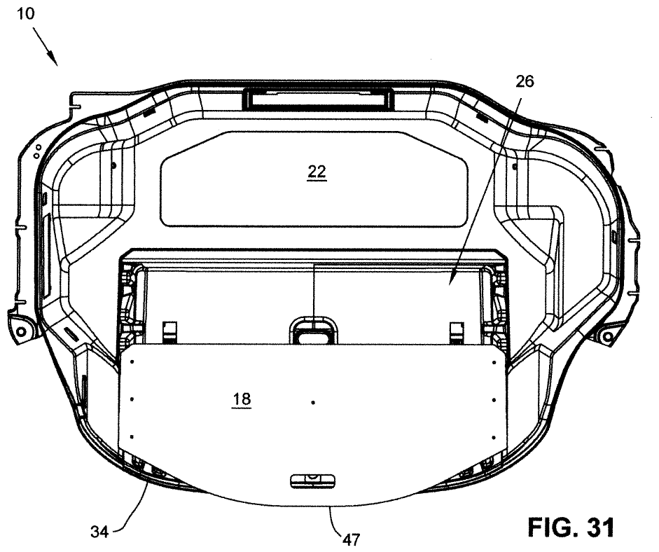

When use of the table assembly 17 is desired, same is movable into the position shown in FIGS. 28-31. Specifically, the user inserts their hand into the aligned openings 44 and 45 of the tabletop 18 and the lower table member 40 and pulls upwardly and forwardly on the table assembly 17, which causes the front and rear link arms 62 and 64 to pivot forwardly (counterclockwise in FIG. 30) about their respective lower pivot axes 128 and 132 (FIG. 23) and about their respective upper pivot axes 79A and 97A, and the tabletop 18 and lower table member 40 are moved forwardly as a unit until the position shown in FIG. 30 is reached. In this position, the table assembly 17 is oriented horizontally and is elevated upwardly from its prior position and the frontmost edges 47 and 48 of the tabletop 18 and the lower table member 40 are positioned so that they are generally vertically aligned with the forwardmost edge of the front panel 34. Further, the supports 57 on the lower surface of the lower table member 40 are positioned atop a forwardly located flat wall portion 57A of the housing shell 16, and the pins 80A of the latches 78 on the front link arms 62 are positioned just below the stop brackets 53. In this position, the pins 80A, and specifically the outermost free ends 80B thereof, come into engagement with the lower cam surfaces 43A of the respective cam members 43, and are maintained in contact with the lower cam surfaces 43A via the biasing force of their associated springs 81.

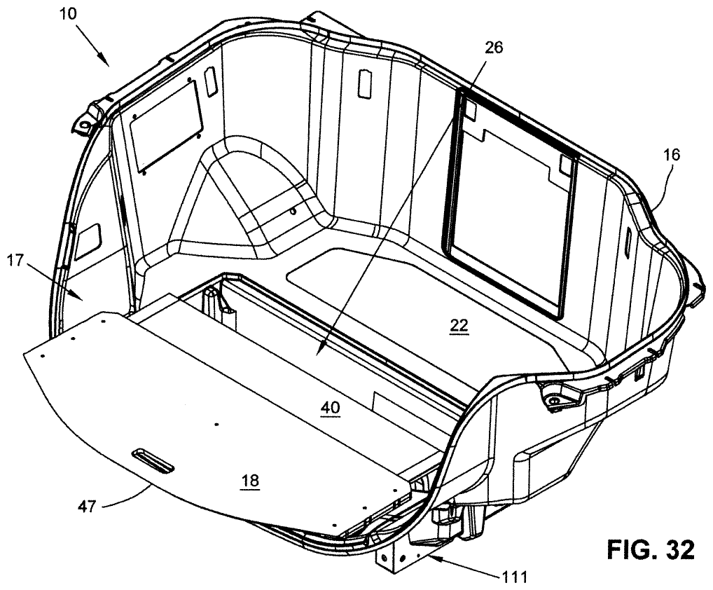

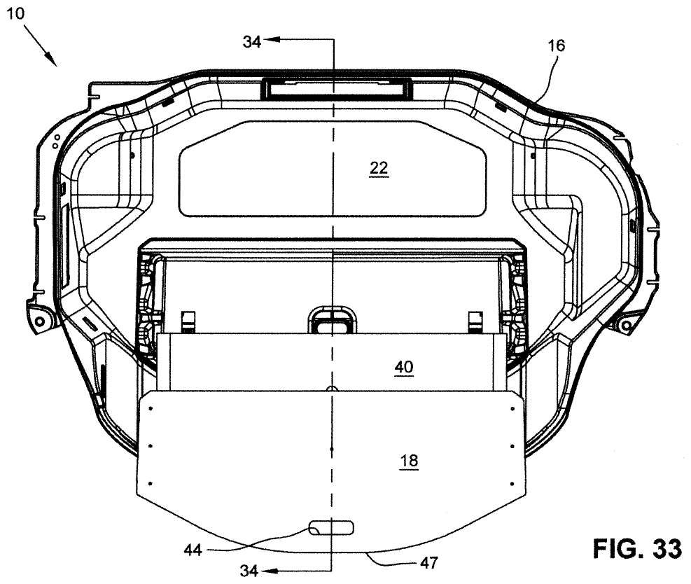

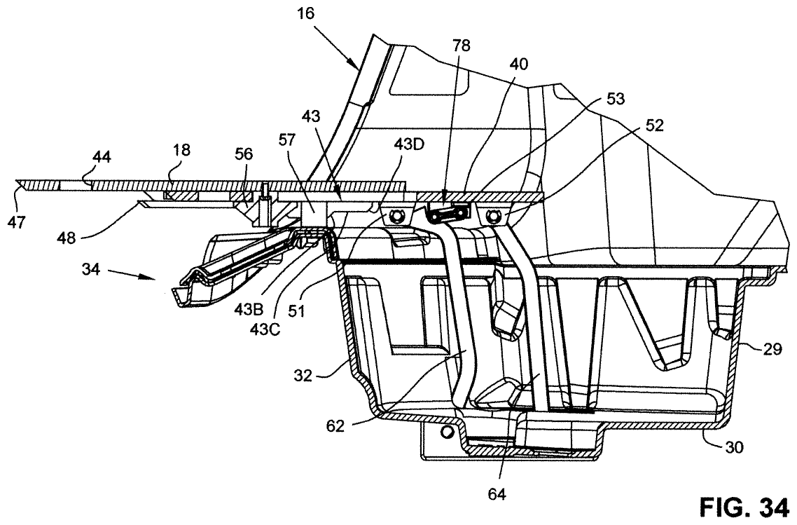

An additional use position of the table assembly 17 is illustrated in FIGS. 32-34, which position provides the user with improved access to the tabletop 18 of the table assembly 17. In this regard, the tabletop 18 can be moved forwardly relative to the lower table member 40 so as to extend the tabletop 18 beyond the front edge 48 of the lower table member 40. Specifically, the user grasps inside the opening 44 of the tabletop 18 and pulls the tabletop 18 forwardly relative to the lower table member 40, which lower table member 40 remains stationary. This movement causes the stop or travel limiter 56 on the tabletop 18 to slide forwardly within the slot 55 of the lower table member 40. The stop 56 limits the forward extension of the tabletop 18 relative to the lower table member 40 when the stop 56 reaches the front end of the slot 55, which prevents the tabletop 18 from detaching from the lower table member 40. When moving the tabletop 18 into a forward extension position, the cam members 43 of the channel members 42 are shifted forwardly along with the tabletop 18, which causes the outermost ends 80B of the pins 80A of the latches 78 to move out of contact with the respective lower cam surfaces 43A and to slide up and along the intermediate cam surface 43B and towards the lower cam surface 43C, until the ends 80B of the pins 80A are free of the respective cam members 43. This movement of the cam members 43 allows the pins 80A on the front link arms 62 to enter the respective channels 54 of the stop brackets 53, as shown in FIG. 34, under the action of the springs 81. Once the pins 80A are fully engaged in the stop brackets 53, the table assembly 17 is locked and will be prevented from being moved back into the closed position, unless the tabletop 18 is again moved rearwardly into its initial position. In this regard, as the tabletop 18 is moved back towards its initial position, the ends 80B of the pins 80A eventually engage the angled cam surfaces 43D of the respective cam members 43, move along the upper cam surfaces 43C and then along the intermediate angled cam surfaces 43B and into engagement with the lower cam surfaces 43A so that the pins 80A move out of the respective channels 54 of the stop brackets 53. The table assembly 17 is now unlocked, and continued pressure on the table assembly 17 in a rearward direction causes the front and rear link arms 62 and 64 to pivot rearwardly (clockwise in the illustrated views) until the table assembly 17 again reaches the closed or storage position.

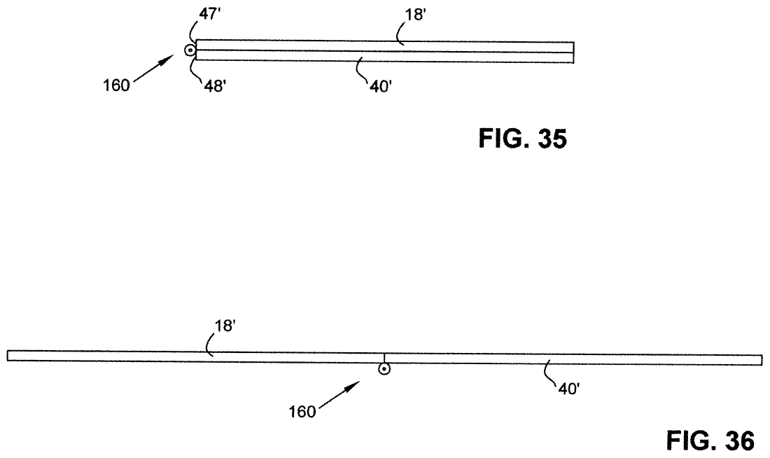

FIGS. 35 and 36 illustrate a table assembly 17′ according to another embodiment of the invention. The table assembly 17′ is substantially identical to the table assembly 17, and components of the table assembly 17′ which are identical or similar to components of the table assembly 17 will include the same reference numbers, plus a “′”. In this embodiment, the table assembly 17′ includes a tabletop 18′ and a lower table member 40′. The tabletop 18′ is positioned atop the lower table member 40′ as in the prior embodiment. However, the illustrated tabletop 18′does not include channel members engaged with the lower table member 40′ and instead is connected to the lower table member 40′ by a hinge 160. More specifically, the hinge 160 is positioned so as to interconnect the tabletop 18′and the lower table member 40′ at their respective frontmost edges 47′ and 48′, such that the tabletop 18′ is pivotable about a horizontal axis defined by the hinge 160. In accordance with this embodiment of the table assembly 17′, the table assembly 17′ is movable into the upper use position depicted in FIGS. 28-31 in the same manner as described above. However, instead of sliding the tabletop forwardly relative to the lower table member to reach the use position depicted in FIGS. 32-34, the tabletop 18′, by grasping the rearmost edge thereof opposite the frontmost edge 47′, is pivoted or swung upwardly and away from the lower table member 40′ and into the extended position illustrated in FIG. 36. In this extended position, the tabletop 18′projects outwardly from the cargo space 14 and beyond the front panel 34 of the housing shell 16. It will be appreciated that the tabletop 18′, adjacent its rearmost edge, may be provided with a knob or handle to assist the user in swinging the tabletop 18′ up and away from the lower table member 40′.

It will be appreciated that the link arm assembly disclosed herein is only an example of one type of mechanism which may be used to convey the table assembly between the closed and use positions thereof as described above. For example, a cam arrangement may be utilized in which several cam members slide relative to one another so as to lift and lower the table assembly. Further, a bar lift (or X-bar) mechanism, a four bar linkage mechanism, or a gooseneck mechanism may also be used as conveying mechanisms for the table assembly.

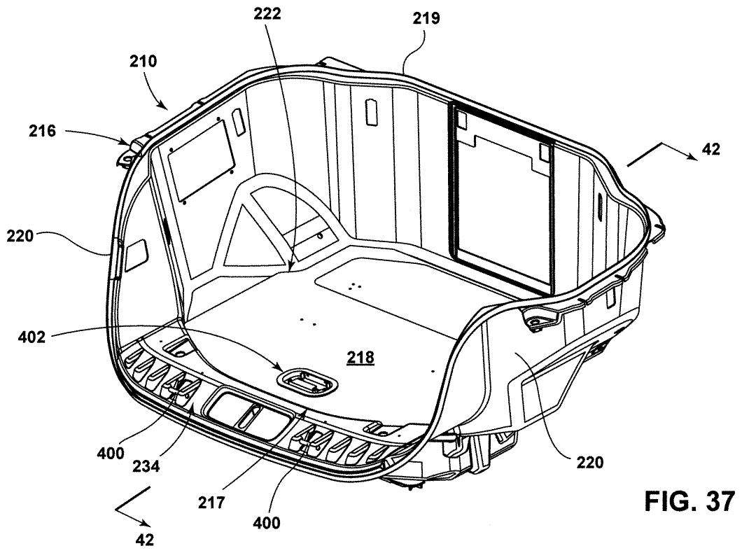

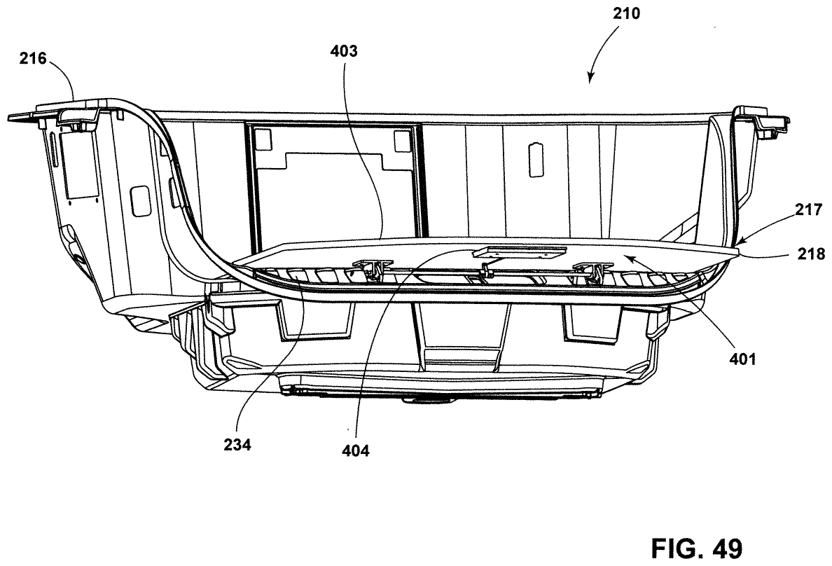

FIGS. 37-49 illustrate a further embodiment of the table arrangement. This embodiment includes a table arrangement 210 for incorporation into a vehicle, such as the vehicle 12, so as to form a cargo space therein, such as the cargo space 14 discussed previously. Components of this embodiment of the table arrangement 210 which are similar or identical to components of the table arrangement 10 will include the same references numbers, plus “200”. Further, a detailed discussion of components which are identical or similar to components of the prior embodiment will not be provided here.

With reference to FIGS. 37-39, the table arrangement 210 includes a housing shell 216 and a table assembly 217 incorporated into a lower portion of the housing shell 216, which table assembly 217 includes a tabletop 218. In this embodiment the tabletop 218 itself forms substantially the entirety of the bottom wall 222 of the housing shell 216, and defines a generally horizontal cargo support surface on which items can be stored and transported when the table assembly 217 is not in use.

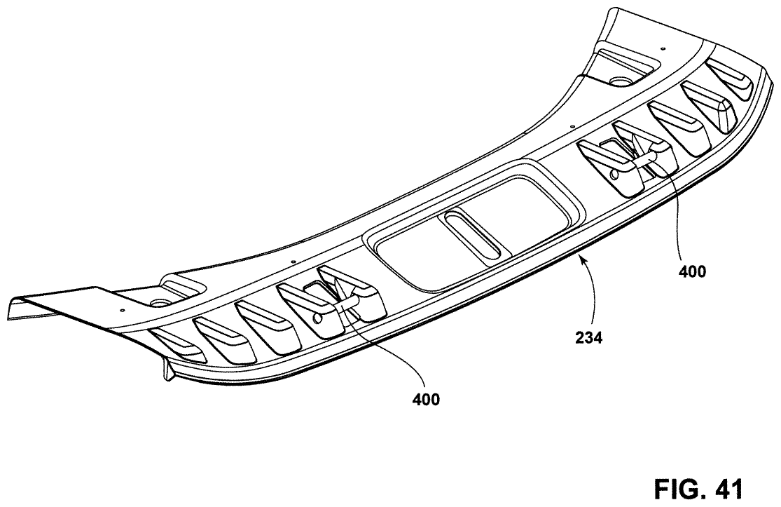

As best shown in FIGS. 37 and 41, the housing shell 216 fixedly mounts thereon a front panel 234 adjacent and along a front edge portion thereof, which front panel 234 forms the terminal frontmost part of the table arrangement 210. In this embodiment, the front panel 234 mounts thereon a pair of horizontally-oriented lock rods 400 which are spaced from one another adjacent respective opposite ends of the front panel 234. The lock rods 400 cooperate with the table assembly 17 to lock same in the open or use position, as discussed further below.

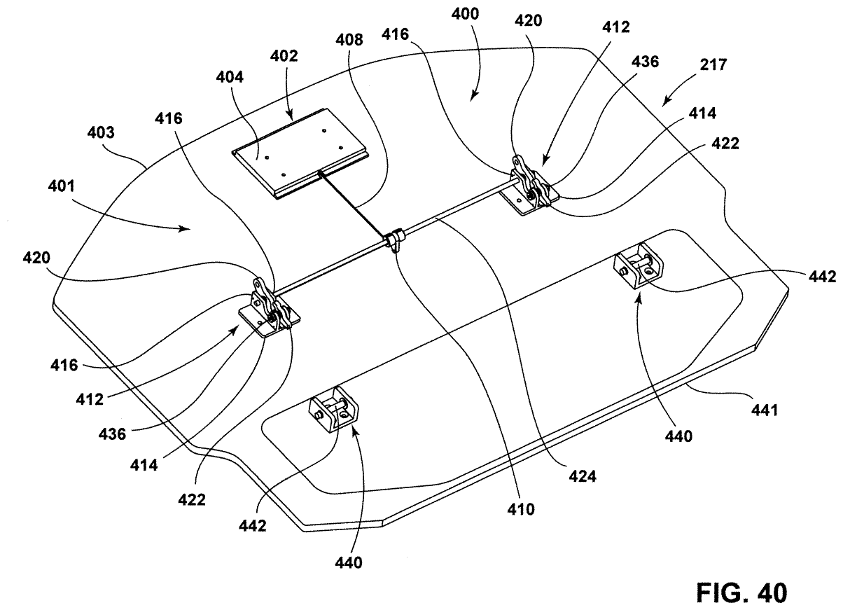

Turning now to the table assembly 217 and with reference to FIGS. 40 and 43 and 44, the table assembly 217 includes the tabletop 218 which is a rigid member, and incorporates a locking arrangement 401 which serves to lock the tabletop 218 in the use position and to release the tabletop 218 so that same can be moved into the stored or closed position. The locking arrangement 401 includes a locking mechanism 402 mounted on the tabletop 218 generally adjacent a front edge portion 403 thereof. The locking mechanism 402 in the illustrated embodiment is mounted in an opening defined in the tabletop 218 and has a housing 404 in which a lock slider 406 is mounted for movement relative thereto in a front-to-back direction of the tabletop 218. The locking arrangement 401 additionally includes a release cable 408 and an actuator 410, both disposed on the lower side of the tabletop 218. The release cable 408 is fixed to the lock slider 406 at one end and at the opposite end is fixed to the actuator 410.

As best shown in FIG. 40, the locking arrangement 401 includes a pair of identical lock brackets 412 fixed to the lower side of the tabletop 218 in a laterally spaced apart manner from one another. Each of the lock brackets 412 has a base 414 fixed to the lower side of the tabletop 218 and a pair of upright flanges 416 fixed to the base 414 in a spaced-apart manner from one another. The locking arrangement 401 also includes a cam arrangement including a release cam 420 and a striker cam 422 supported on each of the lock brackets 412, and an elongate shaft 424. The two release cams 420 are identical and the two striker cams 422 are identical and only one of each is described further here. The shaft 424 extends between the lock brackets 412 and is supported on the lock brackets 412 for rotational movement relative thereto. One release cam 420 and one striker cam 422 is mounted between each of the flanges 416 of each of the lock brackets 412. With reference to FIGS. 46 and 47, the release cam 420 includes a cam surface 425 on an inner side thereof and a mounting hole 426. The striker cam 422 includes a cam surface 428 on an outer side thereof which is defined by a pair of lobes 430 spaced apart from one another by a recess or trough 432 disposed therebetween, and a mounting hole 434.

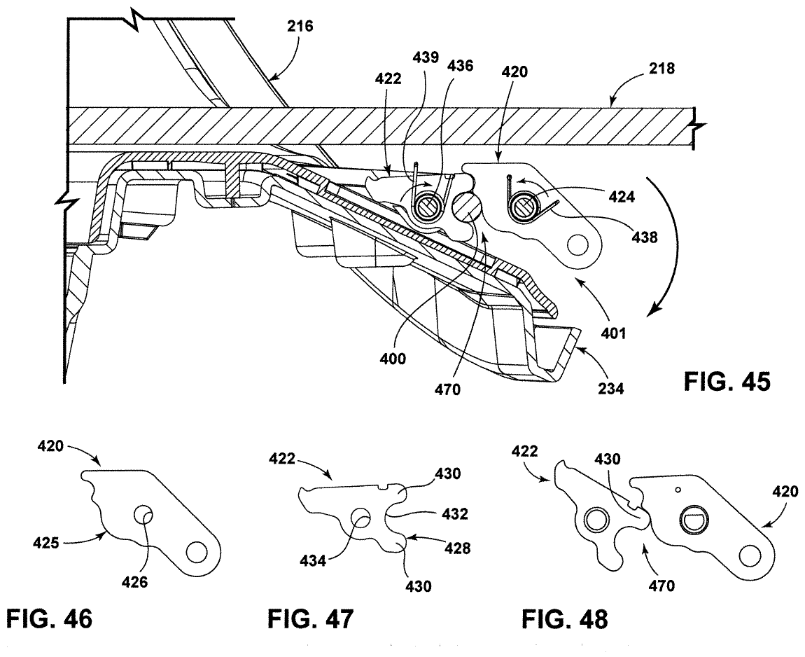

The release cams 420 are mounted on opposite ends of the shaft 424 and each is disposed between the flanges 416 of one of the lock brackets 412, with the respective ends of the shaft 424 extending through the mounting holes 426 to support same. The release cams 420 are rotatably locked to the shaft 424 and as such, the release cams 420 rotate along with the shaft 424. Additionally, a biasing member or spring 438 (FIG. 45) is mounted on the shaft 424 in a manner so as to bias or urge each release cam 420 in the counterclockwise direction (see the arrow in FIG. 45 provided on the release cam 420). The striker cams 422 are positioned rearwardly of the respective release cams 420 on the respective lock brackets 412. More specifically, each striker cam 422 is supported on the respective lock bracket 412 via a pin 436 which extends through the mounting hole 434 of the striker cam 422 so as to support same on the lock bracket 412 for rotation relative thereto. A biasing member or spring 439 is mounted on each of the pins 436 so as to bias each striker cam 422 in the clockwise direction (see the arrow in FIG. 45 provided on the striker cam 422).

The release cam 420 and the striker cam 422 are positioned in the lock bracket 412 so that the cam surface 425 of the release cam 420 and the cam surface 428 face one another with the upper one of the lobes 430 of the striker cam 422 seated in a lower recessed part of the cam surface 425 of the release cam 420 as shown in FIG. 48, which illustrates the unlocked configuration. When the table assembly 17 is in the open and locked position as shown in FIG. 45, the upper lobes 430 of the striker cams 422 are seated in upper recessed parts of the mating cam surfaces 425, and the cam surfaces 428 and 425 engage around the corresponding lock rod 400 of the housing shell 234 so that the lock rod 400 is fixed between the release and striker cams 420 and 422.

Referring back to FIG. 40, the table assembly 217 additionally includes a pair of identical rear and generally U-shaped mounting brackets 440 which are fixed to the lower side of the tabletop 218 so as to be laterally spaced from one another and positioned adjacent opposite side edges of the tabletop 118 and generally adjacent a rear edge portion 441 thereof. Each of the rear mounting brackets 440 includes a pivot rod or pin 442 mounted between respective upright flanges thereof.

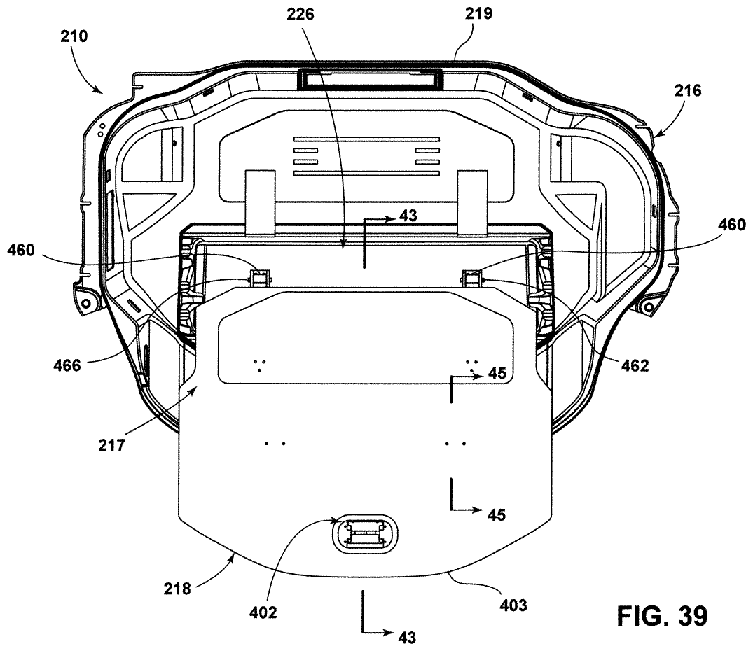

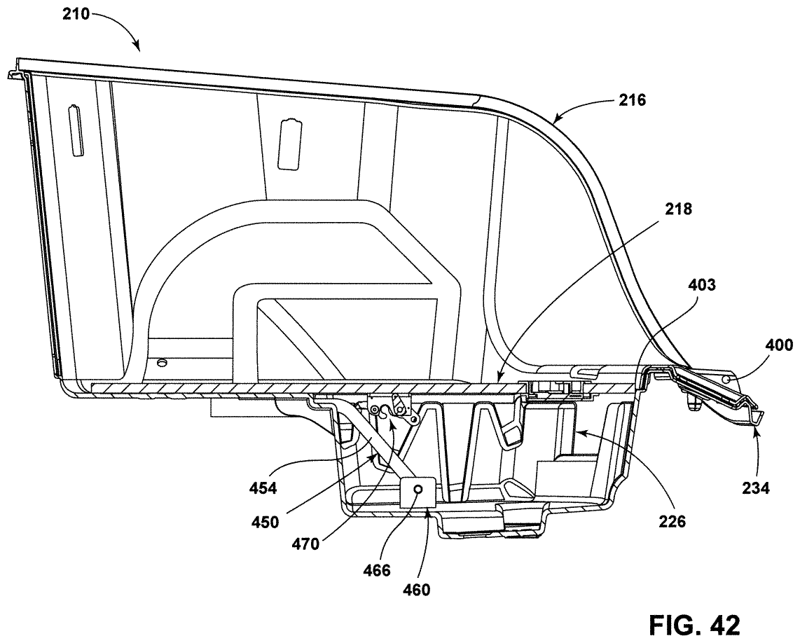

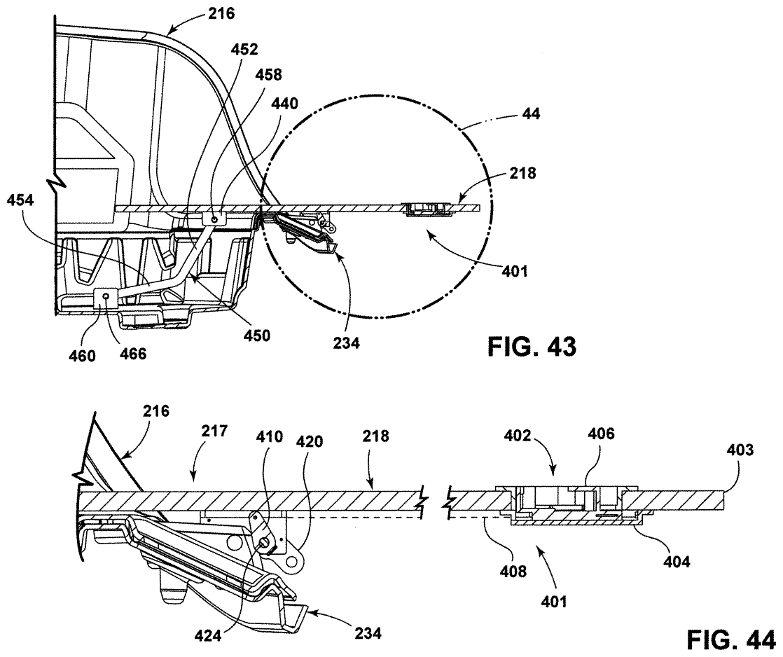

With reference to FIGS. 42 and 43, the table arrangement 210 includes a mechanism or arrangement for conveying the table assembly 217 between the closed or storage position and the open or use position. As in the prior embodiment, the conveying mechanism or arrangement includes a link arm arrangement. However, the link arm arrangement in this embodiment includes only two link arms 450 (only one of which is shown in these views), which link arms 450 are identical and so only one is described here. The link arm 450 includes an upper arm segment 452 and a lower arm segment 454 which are joined to together so that same are oriented at an angle relative to one another. The upper arm segments 452 are mounted to the respective brackets 440 of the table assembly 217 by extending the pivot rods 442 through respective holes (not shown) defined in the upper ends of the respective upper arm segments 452, so that the link arms 450 are pivotable relative to the tabletop 218 about pivot axes 458 defined by the respective pivot rods 442. The conveying mechanism additionally includes a pair of housing brackets 460 (see also FIG. 39) with pins or pivot rods 462. The housing brackets 460 are mounted to the housing shell 216 on opposite sides thereof within the lower storage compartment 226. Lower ends of the lower arm segments 454 of the link arms 450 are each mounted to one of the brackets 460 by extending the pivot rod 462 through a hole (not shown) defined in the lower arm segment 454 so that each of the link arms 450 is pivotable about pivot axes 466 defined by the respective pivot rods 462.

When the table assembly 217 is assembled, the striker cam 422 is biased clockwise by the spring 439 and the release cam 420 is biased by the respective spring 438 in the counter-clockwise direction and into engagement with the mating striker cam 422 such that the cam surface 428 of the striker cam 422 seats against the facing cam surface 425 of the release cam 420 to define the unlocked position (see FIG. 48). The striker cam 422 and the release cam 420 in this position together define a generally downwardly opening receiving area 470 therebetween. Further, the biasing of the release cams 420 in the counter-clockwise direction also serves to bias the shaft 424, to which the release cams 420 are non-rotatably fixed, in the counter-clockwise direction. The release cams 420 and their respective mating striker cams 422, due to the biasing action of the springs 438 and 439, will remain in the unlocked position until an external force is applied, as discussed further below.

When the table assembly 217 is not in use, the link arms 450 of the link arm assembly are stored in the lower storage compartment 226 of the housing shell 216 and the tabletop 218 is oriented generally horizontally, as shown in FIGS. 37 and 42. The weight of the table assembly 217 and friction between same and the housing shell 216 maintain the table assembly 217 in the closed position. However, it will be appreciated that a locking mechanism may be provided to positively lock the table assembly 217 to the housing shell 216 in the closed or non-use position.

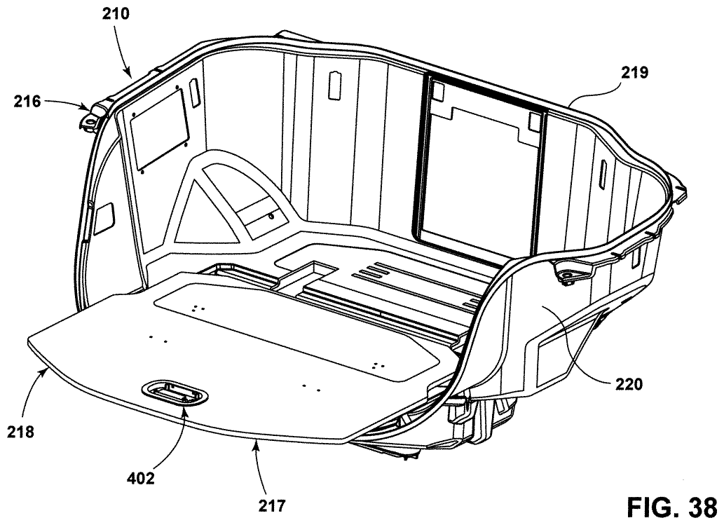

When use of the table assembly 217 is desired, same is movable into the position shown in FIGS. 38, 39, 43-45 and 49. Initially, the pairs of release and striker cams are in the unlocked position of FIG. 48. The user inserts their hand into the lock slider 406 of the locking mechanism 402 provided adjacent the front edge portion 403 of the tabletop 218, and pulls upwardly and forwardly on the table assembly 217, which causes the link arms 450 to pivot forwardly (clockwise in FIG. 42) about their respective pivot axes 466, and the tabletop 218 is moved forwardly until the position shown in FIGS. 43 and 44 is reached. In this position, the table assembly 217 is oriented horizontally and is elevated from its closed or non-use position and the front end portion 403 of the tabletop 218 is positioned forwardly from the frontmost edge of the front housing panel 234. The locking arrangement 401 is configured to automatically cause locking of the tabletop 218 to the housing shell 216 once the tabletop 218 reaches the fully extended position, which is described more specifically below.

As the tabletop 218 approaches its fully extended position, the striker cams 422 approach the respective lock rods 400 of the housing shell front panel 234 and the lock rods 400 come into contact with the striker cams 422 and cause rotation thereof counterclockwise and the upper lobes 430 of the striker cams 422 push their respective release cams 420 in the clockwise or release direction. Continued motion of the tabletop 218 towards the fully extended position causes the lock rods 400 to move further into the respective receiving areas 470, which areas 470 normally face generally downwardly. Once the lock rods 400 fully seat in the respective receiving areas 470, the upper lobes 430 of the striker cams 422 seat in the upper recessed areas of their respective release cams 420 and the striker cam 422 and receiving cam 420 of each pair of cams are moved into the locked position as shown in FIG. 45 so as to snugly engage the lock rods 400 and effectively fix the tabletop 218 in the use position.

When use of the table assembly 217 is no longer desired, the user inserts their hand into the lock slider 406 and slides same in a direction away from the housing shell 216 which causes the release cable 408 to pull on the actuator 410 and rotate same along with the shaft 424 (to which it is fixed), as well as the release cams 420, in the clockwise direction. The clockwise motion of the release cams 420 causes the respective striker cams 422 to rotate clockwise and to pivot about their respective pivot axes defined by the respective pins 436 of the front lock brackets 412. Due to the shapes of the cam surfaces 425 and 428 of the release cam 420 and the striker cam 422, this rotational motion of the striker cams 422 and their mating release cams 420 enlarges the respective receiving areas 470 to effectively release the lock rods 400. The table assembly 217 can now be lifted upwardly and moved rearwardly and into the housing shell 216 into the storage or non-use position. When the lock rods 400 are released from the respective receiving areas 470, the pairs of release cams 420 and striker cams 422 rotate back into the unlocked position (FIG. 48) and remain there until the table assembly 217 is moved into the use position.

Although particular preferred embodiments of the table arrangement have been disclosed in detail for illustrative purposes, it will be recognized that variations or modifications of the disclosed arrangement, including the rearrangement of parts, lie within the scope of the invention.

What is claimed is:

1. A table arrangement for a vehicle, said table arrangement comprising:
a housing comprising:
a bottom wall including an upwardly facing surface defining a support surface for storing or transporting items in a cargo space of the vehicle; and
a storage space disposed below said bottom wall;
a table assembly comprising:
a table defining a generally planar upper surface; and
a conveying arrangement at least partially disposed in said storage space and operatively connected to said table, said conveying arrangement being configured for conveying said table between a storage position and at least one use position, said table in said storage position being disposed adjacent said bottom wall and in substantially flush relation therewith such that said table defines at least part of said support surface in said storage position, said table in said at least one use position being spaced upwardly from said bottom wall.

2. The table arrangement according to claim 1, wherein said table in said at least one use position is spaced both upwardly from said bottom wall and horizontally from an orientation of said table when in said storage position.

3. The table arrangement according to claim 1, wherein said housing comprises an edge portion disposed to define at least part of a lower peripheral edge portion of a cargo space opening frontwardly or rearwardly of the vehicle when said table arrangement is installed thereon, said lower peripheral edge portion being oriented generally in a transverse direction of the vehicle at a front or rear thereof, and said table includes an outer terminal edge portion and in said at least one use position said outer terminal edge portion projects horizontally beyond said lower peripheral edge portion.

4. The table arrangement according to claim 1, wherein said conveying arrangement includes a linking mechanism comprising at least one link arm having a lower end pivotably operatively connected to said housing and an upper end pivotably operatively connected to said table.

5. The table arrangement according to claim 1, wherein said table comprises upper and lower table members disposed in vertically stacked relation with one another, said upper table member being slidably movable relative to said lower table member into said at least one use position, and said upper table member projecting horizontally beyond said lower table member in said at least one use position.

6. A table arrangement for a vehicle, said table arrangement comprising:
a housing including a bottom wall having an upwardly facing surface defining a support surface thereon and a side wall projecting upwardly from a periphery of said bottom wall, said side wall and said bottom wall together defining a cargo space of the vehicle opening rearwardly or frontwardly thereof, said upwardly facing surface defining a floor of said cargo space; and
a table assembly comprising:
a table defining a generally planar upper surface for supporting objects thereon; and
a conveying arrangement at least partially disposed beneath said bottom wall of said housing, said conveying arrangement comprising at least one arm, said at least one arm having a first end portion operatively connected to said table and a second end portion operatively connected to said housing, said at least one arm being movable relative to said housing to convey said table between a storage position and at least one use position, said table in said storage position being disposed adjacent and substantially flush with said bottom wall such that said upper surface of said table defines at least part of said support surface in said storage position, said table in said at least one use position being spaced upwardly from said bottom wall.

7. The table arrangement according to claim 6, wherein said table in said at least one use position is spaced both upwardly from said bottom wall and horizontally from an orientation of said table in said storage position.

8. The table arrangement according to claim 6, wherein said housing comprises an edge portion disposed to define at least part of a lower peripheral edge portion of said cargo space when said table arrangement is installed on the vehicle, said lower peripheral edge portion being oriented generally in a transverse direction of the vehicle at a front or rear thereof, and said table includes an outer terminal edge portion and in said at least one use position said outer terminal edge portion projects horizontally beyond said lower peripheral edge portion of said cargo space.

9. The table arrangement according to claim 6, wherein said first end portion of said at least one arm is pivotably operatively connected to said table and said second end portion of said at least one arm is pivotably operatively connected to said housing.

10. The table arrangement according to claim 6, wherein said table comprises upper and lower table members disposed in vertically stacked relation with one another, said upper table member being slidably movable relative to said lower table member into said at least one use position, and said upper table member projecting horizontally beyond said lower table member in said at least one use position.

11. The table arrangement according to claim 6, wherein said table comprises upper and lower table members disposed in vertically stacked relation with one another, said upper table member being swingably movable relative to said lower table member into said at least one use position, said upper table member projecting horizontally beyond said lower table member in said at least one use position.

12. The table arrangement according to claim 11, wherein said upper and lower table members each include a terminal edge portion oriented transversely to a front-to-back direction of the motor vehicle when said table arrangement is installed thereon, and said table assembly includes a hinge interconnecting said terminal edge portions of said upper and lower table members.

13. The table arrangement according to claim 6, wherein said table comprises first and second table members, one of said first or second table member being pivotable relative to the other of said first or second table member into said at least one use position.

14. The table arrangement according to claim 6, wherein said at least one arm comprises a pair of laterally-spaced arms each having a first end portion operatively connected to said table and a second end portion operatively connected to said housing.

15. The table arrangement according to claim 6, further comprising a locking arrangement configured to lock said table assembly in the at least one use position such that said table is fixed in the at least one use position.

16. The table arrangement according to claim 15, wherein said locking arrangement comprises a release member mounted on one of said table assembly or said housing shell, said release member when actuated releasing said table assembly from the at least one use position to permit movement into the storage position.

17. The table arrangement according to claim 16, wherein said locking arrangement further comprises a lock member non-movably fixed to said housing and a cam arrangement fixed to said table and configured to cooperate with said lock member.

18. The table arrangement according to claim 17, wherein said cam arrangement includes at least one rotatable cam member normally biased in a first rotational direction and operatively connected to said release member, said release member being actuable to move said at least one rotatable cam member in a second rotational direction opposite the first rotational direction to release the lock member and permit movement of said table assembly from the at least one use position to the storage position.

19. The table arrangement according to claim 17, wherein said cam arrangement includes a pair of rotatable first and second cam members normally biased in first and second opposite rotational directions from one another and operatively connected to said release member, said first and second cam members together defining an opening configured for receiving said lock member therebetween, said release member being actuable to move at least one of said first or second cam members in a direction opposite to the first or second rotational direction to release said lock member.

20. The table arrangement according to claim 19, wherein said cam arrangement is mounted on a lower surface of said table, and said release member is accessible from an upper surface of said table.
